(19) United States
(12) Patent Application Publication
(10) Pub. No.: US 2010/0299488 A1
(43) Pub. Date: Nov. 25, 2010

(54) DYNAMIC MEMORY ACCESS METHOD AND MEMORY CONTROLLER

(75) Inventors: Te-Lin Ping, Hsinchu City (TW); I-Huan Huang, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/534,160

(22) Filed: Aug. 3, 2009

(30) Foreign Application Priority Data
May 25, 2009 (TW) 98117336

(51) Int. Cl. G06F 12/00; G06F 12/10

(52) U.S. Cl. 711/154; 711/206; 711/E12.001

(57) ABSTRACT

A dynamic memory access method includes following steps. First, many data access commands are received. Each of the data access commands accesses a dynamic memory according to a page address and a bank address. Next, whether an access data to be accessed by the corresponding data access command is an instantaneous data or a non-instantaneous data is determined. Then, the page and bank addresses of each of the data access commands are respectively compared with a previously page and bank addresses at a previous time used for accessing the dynamic memory, such that an address hit status is obtained. Next, a service sequence is generated according to whether each of the data access commands is an instantaneous or instantaneous data and the address hit status of the commands. Finally, each of the data access commands is executed to access the dynamic memory sequentially according to the service sequence.

### CROSS-REFERENCE TO RELATED APPLICATION

This application claims the priority benefit of Taiwan application serial no. 98117336, filed on May 25, 2009. The entirety of the above-mentioned patent application is hereby incorporated by reference herein and made a part of specification.

### BACKGROUND OF THE INVENTION

1. Field of the Invention

The present invention relates to a dynamic memory access method.

2. Description of Related Art

With the great improvement of electronic technology, electronic products with multi-function have become a new trend. Thus, designers need to integrate many devices with different functions into one system, so as to provide a multi-function electronic product in the light of said demands. Taking a TV system for example, besides a display controller, a image compression/decompression controller, and an audio controller are required during playing images, a CPU and related peripheral controllers for providing peripheral functions (e.g. a real time recording or a pre-programmed recording) are also required. The devices mentioned above in the TV system all require accessing the dynamic memory of the TV system. Thus, in order to ensure each of the devices is able to access the needed data in real time, how to efficiently use the limited bandwidth of the dynamic memory becomes an essential topic.

When the dynamic memory is accessed during page-changing operation, a page-changing command requires being executed. Hence, as many clients access the dynamic memory at the same time, the condition the dynamic memory accessed with a lot of different page addresses occurs, which results in the waste of bandwidth because the page-changing command is continuously executed. Referring to FIG. 1, FIG. 1 is an access waveform schematic of a conventional dynamic memory. The dynamic memory is accessed according to a clock signal CK. An instruction signal INS is used to control the dynamic memory (e.g. open a corresponding page address or a bank address), and a data signal DATA is used to transmit an access data. After the instruction signal INS opens a page address A1 of the dynamic memory, the access data is transmitted via the data signal DATA. If another page address of the dynamic then requires being accessed, the instruction signal INS requires opening a bank address AB1 and a new page address B1 via a transmission instruction. During the opening period of the bank address AB1 and the new page address B1, the access data is not able to be transmitted by the data signal DATA, such that the waste of bandwidth occurs.

### SUMMARY OF THE INVENTION

The present invention provides a dynamic memory access method, so that the bandwidth usage of the dynamic memory is optimized.

The present invention provides a memory controller, which accesses a dynamic memory through a method of optimized bandwidth usage.

The present invention provides a dynamic memory access method including following steps. First, a plurality of data access commands are received. Each of the data access commands accesses a dynamic memory according to a page address and a bank address. Next, whether an access data to be accessed by the corresponding data access command is an instantaneous data or a non-instantaneous data is determined. Then, the page and bank addresses of each of the data access commands are respectively compared with previously page and bank addresses at a previous time used for accessing the dynamic memory, such that an address hit status of each of the data access commands is obtained. Next, a service sequence is generated according to whether the access data of each of the data access commands is an instantaneous data or a non-instantaneous data and the address hit status of each of the data access commands. Finally, each of the data access commands is sequentially executed to access the dynamic memory according to the corresponding service sequence of each of the data access commands.

In an embodiment of the present invention, when the access data of each of the data access commands is the instantaneous data, the service sequence generated correspondingly is prior to the service sequence generated correspondingly when the access data of each of the data access command is the non-instantaneous data.

In an embodiment of the present invention, the address hit statuses include the following. 1) The page address and the previous page address are the same. 2) The page address and the previous page address are different, and the bank address and the previous bank address are different. 3) The page address and the previous page address are different, but the bank address and the previous bank address are the same.

In an embodiment of the present invention, when the address hit status is the page address and the previous page address being the same, the service sequence generated correspondingly is prior to the service sequence generated correspondingly when the service sequence generator determines the page address and the previous page address are different and the bank address and the previous bank address are different. Besides, when the page address and the previous page address are different and the bank address and the previous bank address are different, the service sequence generated correspondingly is prior to the service sequence generated correspondingly when the page address and the previous page address are different but the bank address and the previous bank address are the same.

In an embodiment of the present invention, the method further includes rearranging each of the data access commands in which the page address and the previous page address are different and the bank address and the previous bank address are the same, and sequentially executing each of the data access commands which have the same page address.

In an embodiment of the present invention, the method further includes determining a waiting time of each of the data access commands, and when the waiting time exceeds a presetting maximum waiting time, each of the corresponding data access commands is directly executed.

In an embodiment of the present invention, wherein when each of the data access commands in which the access data is the instantaneous data, each of the access data is accessed in the dynamic memory in real time.

In an embodiment of the present invention, the data access commands are respectively sent by a plurality of clients.

In an embodiment of the present invention, the clients include a display controller, an image compression/decompression controller, a peripheral controller, a CPU and an audio controller.

The present invention provides a memory controller for accessing a dynamic memory. The memory controller includes an arbiter, a service sequence generator and an access controller. The arbiter receives a plurality of data access commands, wherein each of the data access commands accesses a dynamic memory according to a page address and a bank address. The arbiter then determines whether an access data to be accessed by the corresponding data access command is an instantaneous data or a non-instantaneous data. The service sequence generator is coupled to the arbiter and respectively compares the page address and the bank address of each of the data access commands with a previous page address and a previous bank address at a previous time used for accessing the dynamic memory, so as to obtain an address hit status of each of the data access commands. The service sequence generator generates a service sequence according to whether the access data of each of the data access commands is the instantaneous data or the non-instantaneous data and the address hit status of each of the data access commands. The access controller is coupled to the service sequence generator and sequentially executes each of the data access commands to access the dynamic memory according to the corresponding service sequence of each of the data access commands.

In an embodiment of the present invention, the service sequence generator includes a buffer for storing each of related information of the data access commands which are not yet executed.

In view of the above, the embodiments of the present invention sort the order of the data access commands according to the instantaneous or non-instantaneous characteristic of each of the data access commands. Furthermore, the order of the data access commands are according to the address hit status. The address hit status is determined by comparing the page address of the corresponding command and the previous page address at the previous time used for accessing the dynamic memory, and comparing the bank address and the previous bank address at a previous time used for accessing the dynamic memory.

Thus, the dynamic memory is accessed in the most efficient manner.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an access waveform schematic of a conventional dynamic memory.

FIG. 2 is a schematic of memory controller in an embodiment of the present invention.

FIG. 3 is a schematic of memory controller 200 in another embodiment of the present invention.

FIG. 4 and FIG. 5 are flowcharts of a dynamic memory access method in an embodiment of the present invention.

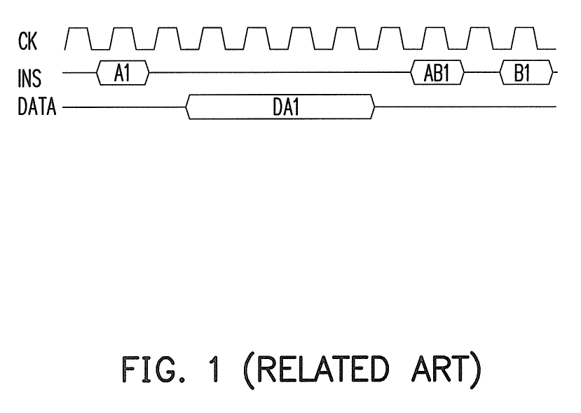

### DESCRIPTION OF EMBODIMENTS

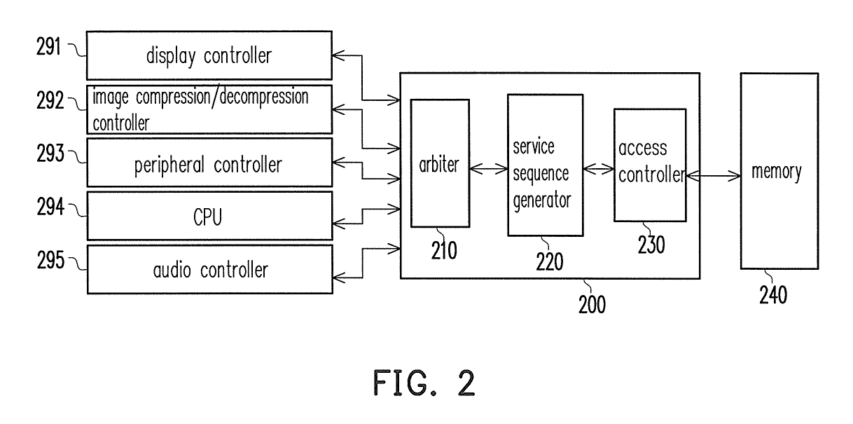

FIG. 2 is a schematic of memory controller 200 in an embodiment of the present invention. Referring to FIG. 2, the memory controller 200 includes an arbiter 210, a service sequence generator 220 and access controller 230. The memory controller 200 is used for accessing a memory 240, which is a dynamic memory. In addition, devices that send data access commands are a plurality of clients, for example a display controller 291, an image compression/decompression controller 292, a peripheral controller 293, a CPU 294 and an audio controller 295.

The arbiter 210 receives a plurality of data access commands from the clients, wherein each of the data access commands accesses the dynamic memory 240 according to a page address and a bank address. The arbiter 210 then determines whether an access data to be accessed by the corresponding data access command is an instantaneous data or a non-instantaneous data. It should be mentioned that the instantaneous data are the access data which require real time successive storage in or retrieval from the memory 240 for client transmission. On the other hand, the non-instantaneous data are the access data which are not necessarily real time successive storage in or retrieval from the dynamic memory 240 for client transmission. Instead, the non-instantaneous data are the access data which are able to idle for a predetermined period before being accessed.

Besides, the access data are the instantaneous data or the non-instantaneous data are determined according to the application of the access data. For example, the access data which the audio controller 295 requires are the instantaneous data. If the access data of the audio are not accessed real time, no sound occurs or even explosion sounds occur during playback of the audio due to absence of the access data.

On the other hand, the access data which the display controller 291 requires are generally the non-instantaneous data. This is because a display device refreshes data every frame period. Compared with those accessed by a dynamic memory with high access speed, the access data which the display controller 291 requires are not the instantaneous data requires to be successively accessed in real time.

The service sequence generator 220 is coupled to the arbiter 210. After the arbiter 210 determines whether the access data to be accessed by the corresponding data access command is the instantaneous data or the non-instantaneous data, the service sequence generator 220 determines access addresses of each of the data access commands used for accessing the dynamic memory 240 accordingly. In addition, the so-called access addresses of each of the data access commands used for accessing the dynamic memory 240 includes a page address and a bank address. The service sequence generator 220 compares the page address and the bank address of each of the data access commands with a previous page address and a previous bank address at a previous time used for accessing the dynamic memory 240, so as to obtain an address hit status of each of the data access commands.

There are three address hit statuses. That is, the page address and the previous page address are the same. The page address and the previous page address are different, and the bank address and the previous bank address are different. And the page address and the previous page address are different but the bank address and the previous bank address are the same.

It should be noted that, if the dynamic memory 240 is accessed and the page address changed is not required, the dynamic memory 240 is able to be accessed directly. On the other hand, if the dynamic memory 240 is accessed and the page address and the bank address changed are both required, the dynamic memory 240 is able to be accessed via a parallel hidden command, such that waste of bandwidth is reduced. Furthermore, once the dynamic memory 240 is accessed by the data access commands having different page addresses but the same bank addresses, the waste of the bandwidth of the dynamic memory 240 is unavoidable. The parallel hidden command of the dynamic memory access method are well known to those skilled in the pertinent art, and thus no further description is provided hereinafter.

Thus, the service sequence generator 220 classifies the received data access commands and generates a service sequence, such that the dynamic memory 240 is accessed in the most efficient manner. Besides, the data access command corresponding to the instantaneous data is executed prior to the data access command corresponding to the non-instantaneous data. Next, the address hit status of each of the data access commands in which the access data are the instantaneous data is determined. The execution priority of the data access commands corresponding to address hit status is as follows. The highest priority is when the page address and the previous page address of the data access command are the same. The next highest priority is when the page address and the previous page address are different and the bank address and the previous bank address are different. The lowest priority occurs when the page address and the previous page address are different but the bank address and the previous bank addresses are the same.

In addition, in order to enhance the bandwidth usage efficiency of the dynamic memory 240, the service sequence generator 220 further rearranges each of the data access commands in which the page address and the previous page address are different but the bank address and the previous bank address are the same, and sequentially executes each of the data access commands which have the same page address. Hence, the data access commands with the lowest execution priority are respectively executed at the minimum number of page address changes.

Next, the service sequence generator 220 generates the service sequence according to the address hit status of each of the data access commands corresponding to the non-instantaneous data. The method determining the service sequence of each of the data access commands corresponding to the non-instantaneous data is the same as that corresponding to the instantaneous data, so detail descriptions are not repeated hereinafter. It should be noted that, the execution priority of the data access command corresponding to the non-instantaneous data is lower than that corresponding to the instantaneous data.

The access controller 230 coupled to the service sequence generator 220 executes each of the data access commands sequentially to access the dynamic memory 240 according to the corresponding service sequence of each of the data access commands. That is, the access controller 230 reads or writes the dynamic memory 240 according to the service sequence of each of the data access commands. Since the data access commands are precisely sorted in order by the service sequence generator 220 according to each of the corresponding service sequences, the number that the page address of the dynamic memory 240 is changed is at the minimum number. In other words, the bandwidth usage efficiency of the dynamic memory 240 is optimized.

Furthermore, in order to prevent the case that the data access command with lower execution priority is never and will be never executed because the data access command with higher execution priority (e.g. the data access command corresponding to the instantaneous data which is accessed in the dynamic memory 240 without changing page address) continuously inserts in that with lower execution priority. The service sequence generator 220 in the embodiment further adjusts the service sequence of each of the data access commands according to a waiting time of each of the data access commands. Once the service sequence generator 220 detects the waiting time of the data access command exceeds a presetting maximum waiting time, the service sequence generator 220 raises the execution priority of data access command to the highest execution priority. Thus, the access controller 230 directly executes the data access command.

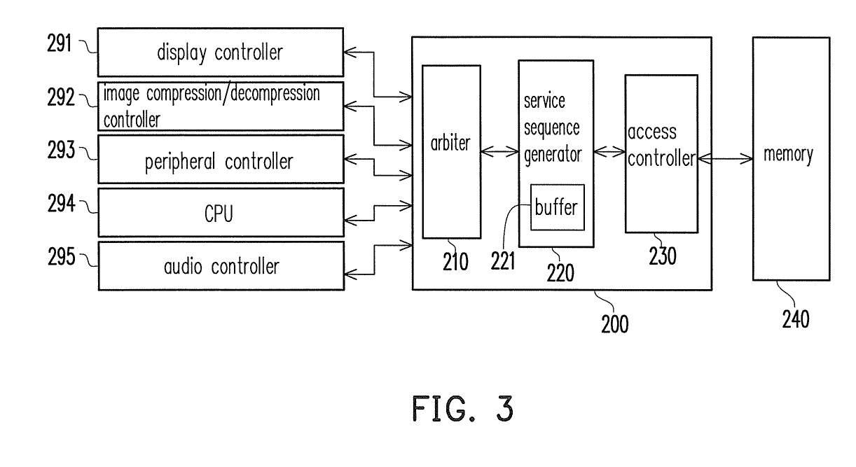

FIG. 3 is a schematic of memory controller 200 in another embodiment of the present invention. Referring to FIG. 3, a buffer 211 is built in the service sequence generator 220 so as to store each of related information of the data access commands which are not yet executed. The related information includes an access data, a flag corresponding to storing or retrieving operation of the data access command, or the page and bank addresses to be accessed by the data access command. The implementation of the added buffer 221 is especially applicable to the instantaneous data processing. In general, since a clock of the client is not synchronous with a clock of the memory controller 200, the arbiter 210 requires synchronizing the two clocks before selecting the data access command. The most common clock synchronization method uses two D-type Flip Flops (DFFs) which are series-connected to accomplish clock synchronization. In other words, the operation of the arbiter 210 is delayed by two clocks during the clock synchronization. Since the buffer 221 is added in the embodiment, the data access commands are able to be stored in the buffer 221. Thus, the above-mentioned operation of the clock synchronization is not required, such that the efficiency loss due to the frequency transformation is compensated by the buffer 221.

It is worth mentioning that the buffer 221 does not restrict to be built in the service sequence generator 220 as shown in FIG. 2. As long as the buffer 221 is able to provide the storage function, it is able to be disposed in any position of the memory controller 200.

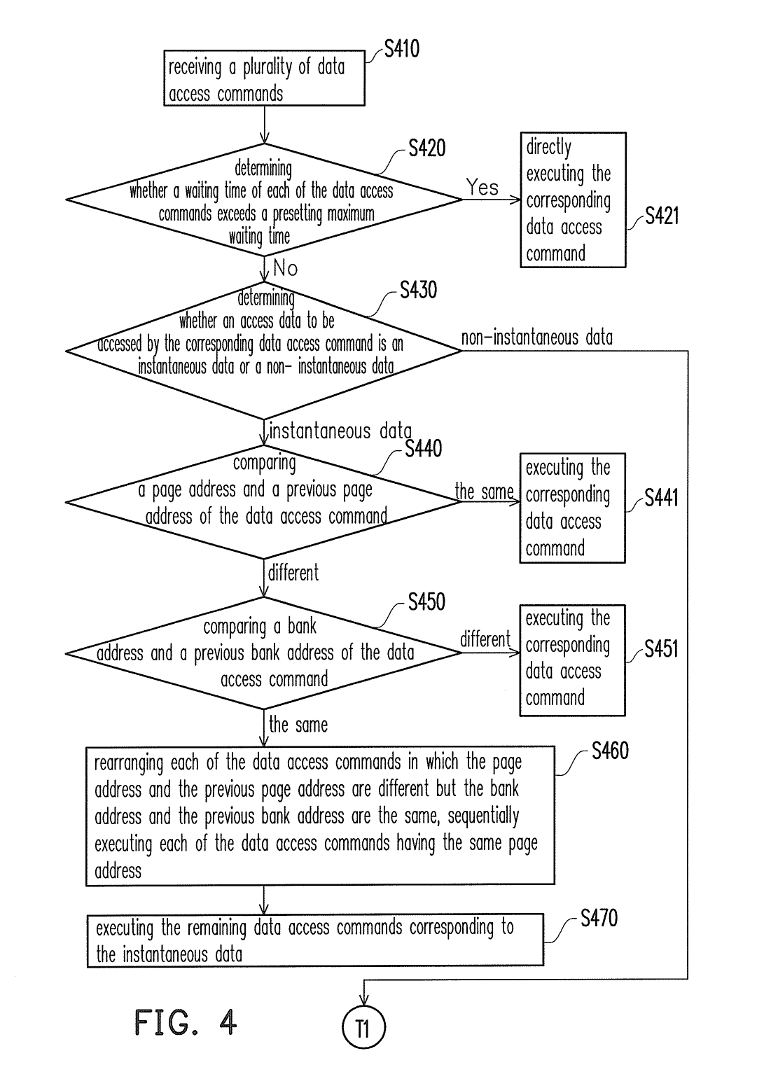

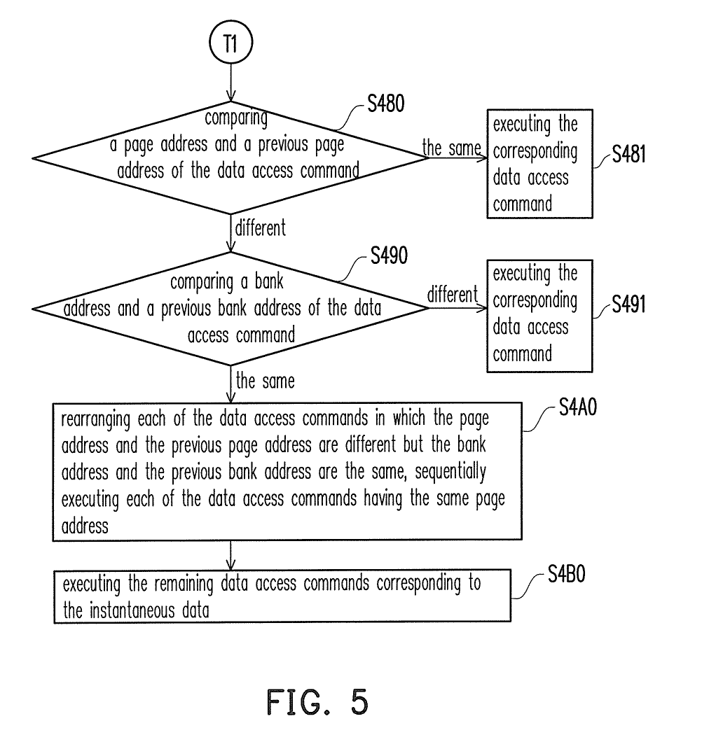

FIG. 4 and FIG. 5 are flowcharts of a dynamic memory access method in an embodiment of the present invention. Referring to both FIGS. 4 and 5, first, a plurality of data access commands are received (S410). Next, whether a waiting time of each of the data access commands exceeds a presetting maximum waiting time is determined (S420). If the waiting time exceeds the presetting maximum waiting time, the corresponding data access command is directly executed (S421). If the waiting time does not exceed the presetting maximum waiting time, whether an access data to be accessed by the corresponding data access command is an instantaneous data or a non-instantaneous data is determined (S430). If the determinant result of the step S430 is the non-instantaneous data, the corresponding data access command waits at a node T1. Conversely, if the determinant result of the step S430 is the instantaneous data, the step S440 is carried out to compare a page address and a previous page address of the data access command.

Once the page address and the previous address of the data access command are the same, which means the page address does not required to be changed, and the corresponding data access command is directly executed (S441). If the page address and the previous address of the data access command are different, a bank address of the data access command is compared with a previous bank address (S450). If the bank address and the previous bank address are different, the data access command is able to directly executed via a parallel hidden command (S451). If the bank address and the previous bank address are the same, step S460 is carried out.

The step S460 is carried out to rearrange each of the data access commands in which the page address and the previous page address are different but the bank address and the previous bank address are the same, and each of the data access commands having the same page address are sequentially executed. After finishing the step S460, step S470 is carried out to execute the remaining data access commands corresponding to the instantaneous data (S470).

Then, after finishing the step S470, following steps are continuously carried out from the node T1. Referring to FIG. 5 hereinafter, steps S480˜S4B0 in FIG. 5 are the same as the steps S440˜S470 in FIG. 4, so detailed description is omitted. It should be noted that the S480˜S4B0 process the data access commands corresponding to the non-instantaneous data, and the S440˜S470 process the data access commands corresponding to the instantaneous data.

Accordingly, the memory controller and the dynamic memory access method of the embodiments classify the access data accessed by the corresponding data access command is the instantaneous data or the non-instantaneous data, and sort the order of the data access commands according to the address hit statuses, such that the data access commands are sequentially executed. Furthermore, the address hit status is determined by comparing the page address of the corresponding data command and the previous page address at the previous time used for accessing the dynamic memory, and by comparing the bank address and the previous bank address at a previous time used for accessing the dynamic memory. Since the memory controller and the dynamic memory access method of the embodiments effectively reduce the number of times of changing page addresses while the dynamic memory being accessed, the access efficiency of the dynamic memory is enhanced.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A dynamic memory access method comprising:
receiving a plurality of data access commands, wherein each of the data access commands is used for accessing a dynamic memory according to a page address and a bank address;
determining whether an access data to be accessed by the corresponding data access command is an instantaneous data or a non-instantaneous data;
comparing the page address and the bank address of each of the data access commands with a previous page address and a previous bank address respectively at a previous time used for accessing the dynamic memory, such that an address hit status of each of the data access commands is obtained;
generating a service sequence according to whether the access data of each of the data access commands is the instantaneous data or the non-instantaneous data and the address hit status of each of the data access commands; and
executing each of the data access commands sequentially to access the dynamic memory according to the corresponding service sequence of each of the data access commands.

2. The method of claim 1, wherein when the access data of each of the data access commands is the instantaneous data, the service sequence generated correspondingly is prior to the service sequence generated correspondingly when the access data of each of the data access command is the non-instantaneous data.

3. The method of claim 1, wherein the address hit statuses comprises:
the page address and the previous page address being the same, or the page address and the previous page address being different and the bank address and the previous bank address being different, or the page address and the previous page address being different but the bank address and the previous bank address being the same.

4. The method of claim 3, wherein when the address hit status is the page address and the previous page address being the same, the service sequence generated correspondingly is prior to the service sequence generated correspondingly when the page address and the previous page address are different and the bank address and the previous bank address are different, and
when the page address and the previous page address are different and the bank address and the previous bank address are different, the service sequence generated correspondingly is prior to the service sequence generated correspondingly when the page address and the previous page address are different but the bank address and the previous bank address are the same.

5. The method of claim 3, further comprising:
rearranging each of the data access commands in which the page address and the previous page address are different but the bank address and the previous bank address are the same; and
executing each of the data access commands which have the same page addresses sequentially.

6. The method of claim 1, further comprising;
determining a waiting time of each of the data access commands; and
when the waiting time exceeds a presetting maximum waiting time, directly executing each of the corresponding data access commands.

7. The method of claim 1, wherein when each of the data access commands in which the access data is the instantaneous data, each of the access data is successively accessed in the dynamic memory.

8. The method of claim 1, wherein the data access commands are respectively transmitted by a plurality of clients.

9. The method of claim 8, wherein the clients comprise a display controller, an image compression/decompression controller, a peripheral controller, a CPU and an audio controller.

10. A memory controller for accessing a dynamic memory comprising:
an arbiter for receiving a plurality of data access commands, wherein each of the data access commands accesses a dynamic memory according to a page address and a bank address, and the arbiter determines whether an access data to be accessed by the corresponding data access command is an instantaneous data or a non-instantaneous data;
a service sequence generator coupled to the arbiter, respectively comparing the page address and the bank address of each of the data access commands with a previous page address and a previous bank address at a previous time used for accessing the dynamic memory, so as to obtain an address hit status of each of the data access commands, and the service sequence generator generates a service sequence according to whether the access data of each of the data access commands is the instantaneous data or the non-instantaneous data and the address hit status of each of the data access commands; and
an access controller coupled to the service sequence generator, sequentially executing each of the data access commands to access the dynamic memory according to the service sequence of each of the data access commands.

11. The memory controller of claim 10, wherein when the arbiter determines the access data of each of the data access commands is the instantaneous data, the service sequence generated correspondingly by the service sequence generator is prior to the service sequence generated correspondingly by the service sequence generator when the arbiter determines the access data of each of the data access command is the non-instantaneous data.

12. The memory controller of claim 10, wherein the address hit statuses determined by the service sequence generator comprises:
the page address and the previous page address being the same, or the page address and the previous page address being different and the bank address and the previous bank address being different, or the page address and the previous page address being different but the bank address and the previous bank address being the same.

13. The memory controller of claim 12, wherein when the service sequence generator determines the address hit status is the page address and the previous page address being the same, the service sequence generated correspondingly by the service sequence generator is prior to the service sequence generated correspondingly by the service sequence generator when the service sequence generator determines the page address and the previous page address are different and the bank address and the previous bank address are different, and
when the service sequence generator determines the page address and the previous page address are different and the bank address and the previous bank address are different, the service sequence generated correspondingly by the service sequence generator is prior to the service sequence generated correspondingly by the service sequence generator when the service sequence generator determines the page address and the previous page address are different but the bank address and the previous bank address are the same.

14. The memory controller of claim 13, wherein the service sequence generator further rearranges each of the data access commands in which the page address and the previous page address are different but the bank address and the previous bank address are the same, and sequentially executes each of the data access commands which have the same page address.

15. The memory controller of claim 10, wherein the service sequence generator further determines a waiting time of each of the data access commands, and when the waiting time exceeds a presetting maximum waiting time, the service sequence generator orders the access controller to executes each of the data access commands directly corresponding to the waiting time.

16. The memory controller of claim 10, wherein when each of the data access commands in which the access data is the instantaneous data, each of the access data is successively accessed in the dynamic memory.

17. The memory controller of claim 10, wherein the data access commands are respectively sent by a plurality of clients.

18. The memory controller of claim 17, wherein the clients comprise a display controller, an image compression/decompression controller, a peripheral controller, a CPU and an audio controller.

19. The memory controller of claim 10, wherein the service sequence generator comprises a buffer for storing each of related information of the data access commands which are not yet executed.
